(19) United States
(12) Patent Application Publication
(10) Pub. No.: US 2004/0108955 A1
(43) Pub. Date: Jun. 10, 2004

(54) Multiband antenna

(76) Inventor: Peter SjoBlom, Lund (SE)

Correspondence Address: BACHMAN & LAPOINTE, P.C., 900 CHAPEL STREET, SUITE 1201, NEW HAVEN, CT, 06510, US

(21) Appl. No.: 10/317,235

(22) Filed: Dec. 10, 2002

(51) Int. Cl. H01Q 1/24

(52) U.S. Cl. 343/700 MS; 343/702

(57) ABSTRACT

A multiband antenna which includes a carrier (1) with at least two radiators (2, 3) galvanically connected in parallel, and an earth plane (4), characterised in that the radiators (2, 3) are planar and lie in a common, first plane; and that the earth plane (4) is planar and lies in a second plane which is substantially parallel with the first plane.

### TECHNICAL FIELD

The present invention relates to a multiband antenna which comprises a carrier with at least two radiators galvanically connected in parallel, and an earth plane.

### BACKGROUND ART

Communication between different electric or electronic apparatuses can take place according to numerous different standards, for example Bluetooth and WLAN. For such communication, there are open bands, among others the two ISM bands (Industrial Science and Medical) at 2.4-2.5 GHz and 5.15-5825 GHz.

Antennas which are to be employed for communication in the above-outlined contexts should be omnidirectional so that the antenna function is not dependent on the positioning or orientation of the apparatus in which the antenna is placed. Further, there are often, in the environment in which the above-outlined communication takes place, disturbance sources which may be located very close to the apparatus with the antenna.

U.S. Pat. No. 6,337,670 B1 discloses an omnidirectional, broad band antenna of the type described by way of introduction. The antenna according to this publication has a largely quadratic earth plane which is disposed on a carrier which in each one of its four corners has a helical radiator whose longitudinal direction is normal to the earth plane. The four helical radiators are galvanically connected in parallel with one another via diagonally running conductors which meet in the centre point of the carrier which has the radiators. The length of these conductors (approximately a quarter wavelength) is employed for impedance adaptation of the antenna.

The antenna according to the US patent takes up a very large volume, for which reason its employment is greatly limited. Further, it is designed as a single band antenna, for which reason it cannot serve the two frequency bands disclosed by way of introduction at 2.4-2.5 GHz and 5.15-5.825 GHz.

### PROBLEM STRUCTURE

The present invention has for its object to design the antenna intimated by way of introduction so that it will have superior omnidirectional properties, an extremely high degree of efficiency and in addition extremely compact constructional dimensions. Further, the present invention has for its object to design the antenna so that it may be manufactured in an economical and rational manner.

### SOLUTION

The objects forming the basis of the present invention will be attained if the antenna intimated by way of introduction is characterised in that the radiators are planar and lie in a common first plane, and that the earth plane is planar and lies in a second plane which is substantially parallel with the first.

As an important feature in the above-described antenna's impedance adaptation to the standardised system impedance of 50 Ω, it applies according to the invention that the radiators include elements which make an acute angle with an edge of the earth plane.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a plan view of a first embodiment of the antenna according to the present invention;

FIG. 2 is a perspective view of the antenna of FIG. 1;

FIG. 3 is a plan view of a second embodiment of the antenna according to the present invention; and

FIG. 4 illustrates measurement results obtained on measuring the “return loss” for the antenna according to FIGS. 1 and 2.

### DESCRIPTION OF PREFERRED EMBODIMENT

The present invention will be described for exemplification purposes as a dual band antenna, but it can also be designed for resonance in more than two frequency bands.

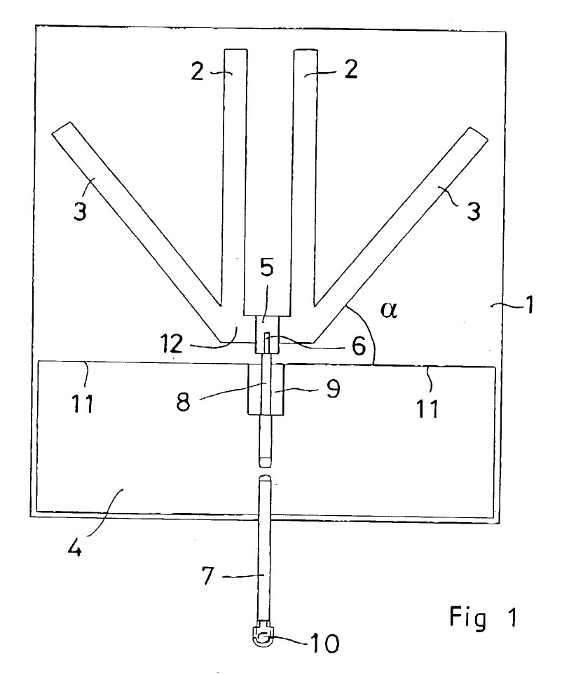

FIG. 1 shows a first embodiment of an antenna according to the present invention. The antenna has a carrier 1 which is produced from an electrically insulating and non-magnetic material. The carrier is panel shaped and, in the illustrated embodiment planar, but may also have a configuration which is adapted to, for example, an apparatus casing in that apparatus in which the antenna is housed. Possibly, the antenna may be disposed directly on the apparatus casing.

The antenna has two first radiators 2 and two second radiators 3, as well as an earth plane 4, all mounted on the carrier 1. Both the first and the second radiators 2 and 3, respectively, and the earth plane 4 are electrically conductive and consist of metal in the form of layers, coatings or foils on the carrier 1 which, for example, may include a circuit card or a flexifilm. In such instance, the radiators 2 and 3 may be disposed on the one side of the carrier while the earth plane 4 is located on the opposite side but, in the preferred embodiment, the radiators and the earth plane are disposed on the same side of the carrier.

The first and second radiators 2 and 3, respectively, have a common supply element 5 to which the central conductor 6 in a coaxial cable 7 is galvanically connected, for example by soldering. The coaxial cable 7 has an outer, earthed conductor 8 which is galvanically connected, for example by soldering, to a supply element 9 on the earth plane. Further, the coaxial cable 7 has a connection contact 10 for connection of the antenna to the electric or electronic apparatus which the antenna is to serve.

The earth plane 4 has a substantially straight edge 11 turned to face towards the radiators 2 and 3 and transversely directed in relation to the longitudinal direction of the first radiators 2. However, this longitudinal direction is preferably at right angles to the edge 11. The first radiators are disposed longitudinally with one another and are preferably parallel and, at the supply element 5, united via a transverse portion 12.

In its opposite ends, i.e. at the edges of the first radiators 2 facing away from one another, the transverse portion 12 is united with the second radiators 3. These extend away from the edge 11 of the earth plane 4 and make an acute angle α therewith. In the illustrated embodiment, the longitudinal direction of the second radiators may approximately be a bisector to the angle between the first radiators and the edge 11. Preferably, the angle α between the longitudinal direction of the second radiators 3 and the edge 11 is approximately 60° or less, preferably approximately 45°.

The radiators 2 and 3 are substantially of the same width in the illustrated embodiment, in which event the first radiators 2 moreover are of slightly greater length than the second radiators 3.

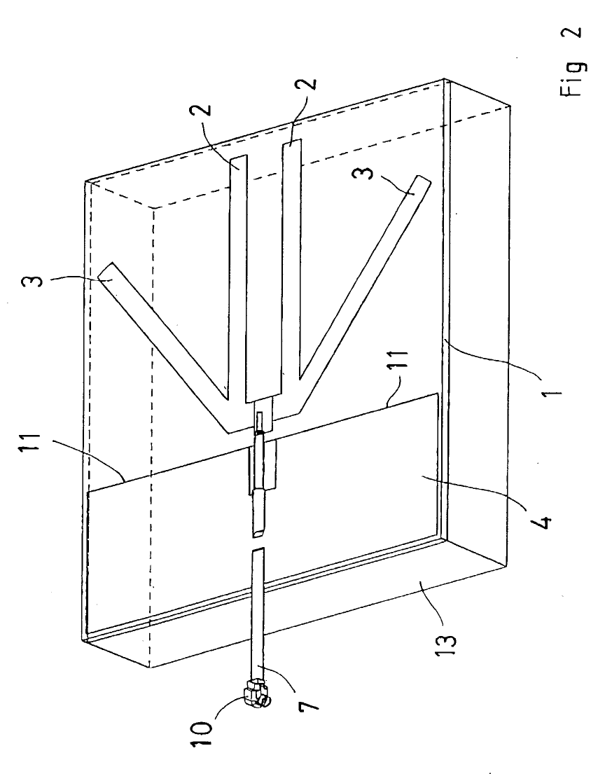

It will be apparent from FIG. 2 that the carrier 1 is applied on a structure 13 which includes a resilient, preferably flexible and insulating, as well as non-magnetic material. It will be apparent from the Figure that the resilient structure 13 has a thickness which is substantially greater than the thickness of the carrier 1 transversely of the plane of extent of the carrier. The resilient structure includes or suitably consists of a foamed material and is, on its side facing away from the carrier 1, provided with an adhesive layer by means of which the antenna and the resilient structure may be secured to an apparatus casing even though this need not be planar.

The antenna according to FIGS. 1 and 2 is, as was mentioned above, a dual band antenna which may be set to the two frequencies 2.4-2.5 GHz and 5.15-5.825 GHz. An antenna with these frequency bands may be employed for radio communication, for example according to any of the standards Bluetooth and WLAN.

It will be apparent from the Figures that both the first radiators 2 and the second radiators 3 have free ends and are end supplied. Both the first and the second radiators have both a quarter wave resonance and a half wave resonance. The quarter wave resonance gives the lower frequency band while the half wave resonance gives the higher frequency band. In that the first and the second radiators 2 and 3, respectively, are of slightly different lengths, the antenna will have greater band width.

In the illustrated embodiment, the first radiators 2 are particularly effective as regards the quarter wave resonance in the lower frequency band and the half wave resonance in the lower half of the higher frequency band. The second radiators 3, which are somewhat shorter than the first, are particularly effective in the upper half of the upper frequency band.

In an operational case, all radiators function as an end supplied half wave radiator which has high impedance, often in the range of 300-500 Ω. The variation in impedance depends on the length/width relationship of the radiator. By parallel connection of several radiators, in this case four in number, the total impedance of the system will be considerably lower and approaches 50 Ω, which is the standardised system impedance today for many types of electric or electronic equipment.

An end supplied quarter wave resonator has, on the other hand, a low impedance often of the order of magnitude of 35-40 Ω and this is also because of the length/width relationship of the radiator. In parallel connection of a plurality of end supplied quarter wave resonators, these would together have an even lower impedance, but this is compensated for in that the second radiators 3 are located more proximal the earth plane 4 and make the angle α of approximately 45° with the edge 11 of the earth plane. In this instance, the pertinent angle may be employed for adjusting the impedance of the antenna in the quarter wave resonance.

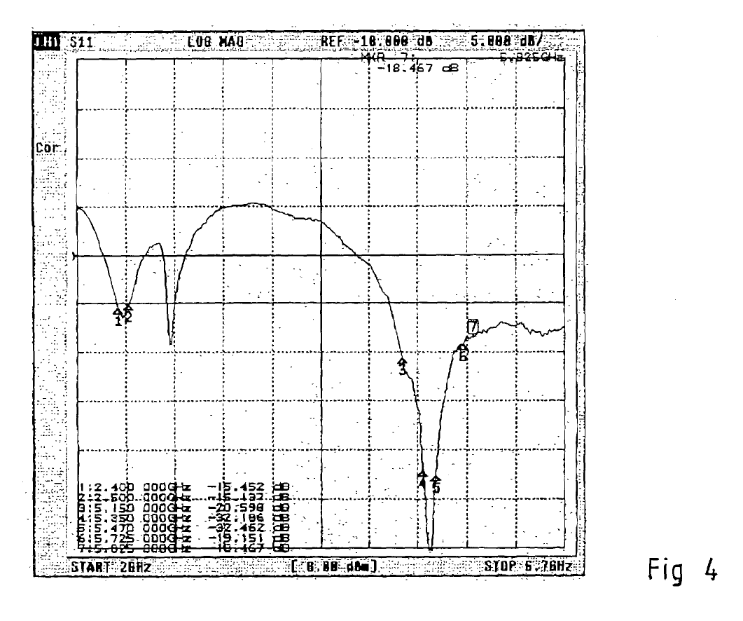

It will be apparent from FIG. 4 that the antenna according to FIGS. 1 and 2 has a first resonance area in the frequency range of 2.4-2.5 GHz, and a second resonance area in the frequency range of 5.15-5.825 GHz. It will be apparent from the Figure that the “return loss” is better than −15 dB in the lower frequency band and better than −20 dB in the higher frequency band. Typical data for a dual band antenna in these frequency areas is not better than −10 dB. Thus, the subject matter of the present invention attains a considerable improvement.

As a result of the arrangement of the first and the second radiators 2 and 3, respectively, illustrated in FIGS. 1 and 2, the antenna will have a large capture surface for incoming radiation. The width of this capture surface is approximately as large as the length of the edge 11 of the earth plane 4. This implies that the antenna makes maximum efficient use of the space available.

It will further be apparent from the foregoing disclosures that the antenna, without the employment of any traditional matching in both of the frequency bands, can be given a favourable impedance of the order of magnitude of 50 Ω.

According to the present invention, it is not necessary that the first and the second radiators 2 and 3, respectively be straight and equally wide conductors of metal. In order to render the antenna more compact, it is possible to impart to the radiators a meandering configuration, provide them with top plastics or extension coils between the connection element 5 and the main parts of the radiators. In the employment of top plastics, the radiators will be physically shorter in the same frequency, have improved band width and be easier to impedance adapt.

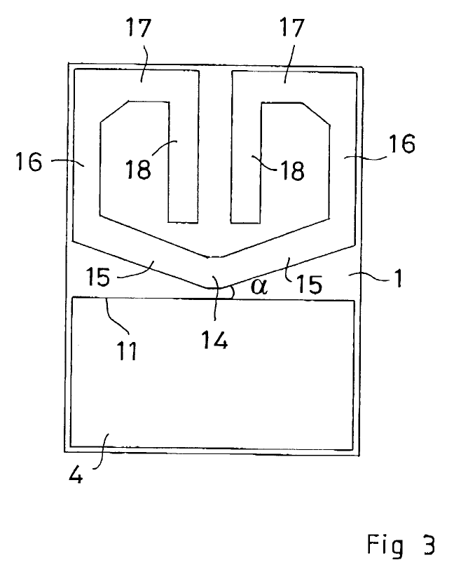

FIG. 3 shows an alternative embodiment of the antenna according to the invention. The major difference compared with the above-described antenna is the fact that it only has two radiators connected in parallel. These radiators have a supply element 14 which is located proximal the transverse edge 11 of the earth plane 4. The radiators illustrated in FIG. 3 have obliquely directed portions 15 which are united with one another in the supply element 14 and whose longitudinal directions make an acute angle with the transverse and closely adjacent edge 11 of the earth plane 4. This angle is less than that which applies to the above-described embodiment and may lie in the order of magnitude of 20°.

The obliquely directed portions 15 of both radiators thus extend in echelon fashion obliquely away from the supply element 14 and the edge 11 of the earth plane 4. At their outer ends, located at opposing edges of the carrier 1, the obliquely directed portions 15 merge in or are connected to side portions 16 which are transversely directed to the edge 11 of the earth plane, and preferably also at right angles thereto. The two side portions are therefore suitably parallel with one another and extend along opposing side edges of the carrier 1.

At the ends of the side portions 16 located most distally from the edge 11, they merge in or are connected to transverse portions 17 which are located at the end of the carrier 1 located most distally from the edge 11 of the earth plane 4. The transverse portions 17 extend towards one another from the opposing side edges of the carrier in towards its centre. At the ends of the transverse portions 17 located most proximal to one another, these are connected to or merge in central portions 18 which are substantially parallel with the side portions 16 and with one another and which extend back towards the earth plane 4, but terminate a slight distance from the obliquely directed portions 15 of the radiators.

FIG. 3 does not show any counterpart to the above-described coaxial cable 7, but it is presupposed that the supply element 14 of the radiators is connected to the central conductor in a coaxial cable and that its outer conductor is connected to the earth plane 4.

The embodiment according to FIG. 3 may also be provided with the above-described resilient structure 13.

The function of the embodiment according to FIG. 3 corresponds to that of the embodiment according to FIGS. 1 and 2. In particular, use is made int. al. of the angle between the edge 11 of the earth plane 4 and the oblique portions for impedance adaptation in quarter wave resonance.

As was mentioned above, the antenna according to the present invention may be designed for resonance in more than two frequency bands. If the additional frequency band or bands lie close to any of the two original bands, it may be sufficient with an increase of the band width of the antenna, e.g. by an increase of the length difference between the first and the second radiators 2 and 3, respectively, in FIGS. 1 and 2. In the embodiment according to FIG. 3, this may be realised in that the left and right-hand radiators are designed in a slightly different manner, e.g. in that they are given slightly different lengths. Other methods of increasing the band widths have also been described above.

If the newly-added frequencies lie further away from the originals, additional resonances must be created. If, for example, in FIG. 1 one of the radiator elements 2 and 3 is given a length that deviates more than that described above, this radiator element alone will have two own resonance frequencies, one half wave and one quarter wave.

In the extreme case, all four radiator elements 2 and 3 in FIG. 1 could have different lengths which would have as a result that the antenna would have a total of eight resonance frequencies.

What is claimed is:

1. A multiband antenna which comprises a carrier (1) with at least two radiators (2, 3) galvanically connected in parallel, and an earth plane (4), characterised in that the radiators (2, 3) are planar and lie in a common, first plane; and that the earth plane (4) is planar and lies in a second plane which is substantially parallel with the first plane.

2. The multiband antenna as claimed in claim 1, characterised in that the first and the second planes substantially coincide.

3. The multiband antenna as claimed in claim 1, characterised in that the radiators (2, 3) have a supply point (5) which is located in the proximity of an edge (11) on the earth plane (4); and that the radiators extend away from this edge.

4. The multiband antenna as claimed in claim 3, characterised in that the radiators (2, 3) in the longitudinal direction of the edge (11) together take up a space whose width substantially corresponds to the length of the edge (11).

5. The multiband antenna as claimed in claim 3, characterised in that the radiators include portions (3, 15) which make an acute angle α with the edge (11).

6. The multiband antenna as claimed in claim 5, characterised in that the angle α is less than or equal to about 60°.

7. The multiband antenna as claimed in claim 5, characterized in that the angle α is less than or equal to about 45°.

8. The multiband antenna as claimed in claim 5, characterised in that the angle α is approximately 20°.

9. The multiband antenna as claimed in claim 1, characterised in that the radiators (2, 3) have a free end.

10. The multiband antenna as claimed in claim 1, characterised in that the radiators include two first, elongate radiators (2) approximately parallel with one another and whose longitudinal directions are transversely directed to an edge (11) of the earth plane (4), and two second, elongate radiators (3) whose longitudinal directions make an angle with one another and the first radiators, the second radiators being disposed on each side of the first radiators.

11. The multiband antenna as claimed in claim 10, characterised in that the first radiators (2) are of greater length than the second radiators (3).

12. The multiband antenna as claimed in claim 10, characterised in that the first (2) and the second (3) radiators are substantially equally wide layers of metal on the carrier (1), which consists of non-magnetic and insulating material.

13. The multiband antenna as claimed in claim 1, characterised in that the radiators are two in number; that the radiators have obliquely directed portions (15) which extend in echelon away from the earth plane (4); and that the obliquely directed portions, in their ends located most distally from the earth plane, merge in or are connected to side portions (16) which are substantially parallel with one another and transversely directed to the edge (11) of the earth plane (4) located most proximal the radiators.

14. The multiband antenna as claimed in claim 13, characterised in that the ends of the side portions (16) facing away from the earth plane (4) are connected to or merge in transverse portions (17) which are directed towards one another and which are substantially parallel with the edge (11) of the earth plane (4); and that the ends of the transverse portions located most proximal one another are connected to or merge in central portions (18) which are substantially parallel with the side portions (16) and which extend towards the earth plane (4).

15. The multiband antenna as claimed in claim 14, characterised in that the radiators are substantially equally wide layers of metal on the carrier (1), which consists of non-magnetic and insulating material.

16. The multiband antenna as claimed in claim 1, characterised in that the carrier (1) has, on one side, a structure (13) of resilient material; and that the resilient structure is of a thickness which is greater than that of the carrier (1).

17. The multiband antenna as claimed in claim 16, wherein the resilient structure is of a flexible, insulating and non-magnetic material.

18. The multiband antenna as claimed in claim 16, characterised in that the resilient structure (13) comprises a foamed material.
